(19) United States
(12) Patent Application Publication
(10) Pub. No.: US 2026/0160872 A1
(43) Pub. Date: Jun. 11, 2026

(54) Precise Time Protocol Network-Based Ping Synchronization System and Method

(71) Applicants: Christopher James Bennett, Eufaula, AL (US); Jean-Sebastien Désiré Albin Stoezel, Winnipeg (CA)

(72) Inventors: Christopher James Bennett, Eufaula, AL (US); Jean-Sebastien Désiré Albin Stoezel, Winnipeg (CA)

(73) Assignee: Johnson Outdoors Inc., Racine, WI (US)

(21) Appl. No.: 18/973,677

(22) Filed: Dec. 9, 2024

(51) Int. Cl. G01S 7/524; G01S 15/96

(52) U.S. Cl. CPC G01S 7/524; G01S 15/96

(57) ABSTRACT

A system and method for use on a recreational watercraft to enable simultaneous usage of multiple sonar systems operated by multiple fish finders installed on the recreational watercraft without causing crosstalk interference between or reducing performance of such sonar systems is presented. The system includes a precise time protocol enabled network configured in accordance with IEEE 1588, multiple fish finders that are members of the PTP network, and a sonar system operated by each of the fish finders. Each of the fish finders control pinging of its sonar system in accordance with a ping schedule and not based on token or permission passing techniques, once their local system clocks are synchronized with a grandmaster clock and a ping clock is derived therefrom. The method includes collecting ping requirements, sorting the fish finders into groups, and generating and broadcasting the ping schedule including time slots for the groups.

### FIELD OF THE INVENTION

This invention generally relates to consumer fish finder sonar control, and more particularly to consumer fish finder sonar control and coordination among multiple sonar transducers on a recreational fishing boat to reduce interference therebetween.

### BACKGROUND OF THE INVENTION

Recreational fishing sonar technology has advanced significantly in recent years and, as such, there has been a higher adoption rate of these different sonar technologies by individual anglers. Indeed, many anglers now regularly install multiple advanced sonar systems on the same fishing boat. While each of these different sonar technologies provide distinct advantages to anglers, one of the drawbacks of having multiple sonar systems on a single fishing boat is that the sonar frequencies used by the transducers of these multiple different sonar systems can interfere with each other when used simultaneously. When such interference occurs, the angler observes degraded performance of these systems. Often, such interference from simultaneously operated sonar systems results in unwanted lines or arcs on the fish finder control head display, which obscures the actual sonar data and degrades the quality of the sonar return display.

Such interference has long been an issue when anglers install and operate two two-dimensional (2D) sonar transducers simultaneously on the same boat from two different control heads. In such a situation, the two transducers typically transmit, or “ping,” at the same or similar frequencies but at different rates or phases. When this happens, each transducer will receive some of the transmitted (or reflected) sonar signal from the other transducer. Since neither fish finder control head knows of the other's operation, such received sonar signal will typically be interpreted as a legitimate sonar return and will be displayed as a vertical line on the display screen of the other fish finder's control head. Such erroneous display of this information obscures the actual sonar return data from that fish finder's transducer. This type of interference is often referred to as crosstalk.

The crosstalk interference problem is not limited only to 2D sonar systems but may also occur when operating multiple different advanced imaging sonar systems. These advanced imaging sonar systems typically transmit and receive in the megahertz (MHz) frequency range in order to provide improved resolution and camara-like images. Such imaging sonar systems typically include down imaging (DI) sonar, side imaging (SI) sonar, 360° imaging sonar, and multi-beam live imaging sonar. Because such advanced imaging sonar systems otherwise provide camera-like images of the underwater environment, the crosstalk interference is particularly irritating.

In an effort to reduce this crosstalk problem, manufacturers of these consumer sonar systems have developed various methods to coordinate the operation of the sonar transducers of different fish finders. In one such method, a token is passed between the control heads of the fish finders that are installed and operating on the boat. The control head of the fish finder that possesses the token pings its transducer and then passes the token to the control head(s) of the other fish finder(s) to allow those fish finders to ping their transducers in turn.

Such a token system allows the control head in possession of the token to ping the transducer or transducers for the sonar systems connected to it. The coordination of the pinging of multiple sonar systems connected to a single control head in a manner not to cause the crosstalk interference issue of those transducers is left to that control head while it is in possession of the token. Once that control head completes its coordinated process, that control head passes the token to the next control head to enable it to begin its sonar transmission(s).

Once all of the control heads have received the token, pinged its transducer or transducers (which may entail coordinated pinging of those multiple transducers by that one fish finder control head as just discussed), and passed the token, the token is returned to the first control head and the process is repeated.

While such token passing methods have been successful in reducing the crosstalk sonar interference issue, it has led to other issues. For example, because only the control head holding the token is allowed to ping it transducer or transducers, and because all of the other control heads must wait to ping their transducers during such time, the ping rate for all control heads is reduced. Such reduction in the ping rate for each of the control heads negatively impacts all of the sonar systems'performance. Further, such token systems have been known to fail due to fish finder hardware timing, high CPU usage, and timing limitations of certain operating systems used on some control heads. These stability issues decrease such a system's effectiveness at reducing interference, particularly when all of the control heads are not operating with the same software release or are made by different manufacturers.

Other attempts to coordinate the operation of the sonar systems controlled by different control heads have also been proposed. One such system utilizes a specialized hardware and software solution that uses a synchronization wire between two sonar modules to control ping timing between two transducers. The synchronization wire has two connection points to control ping synchronization. The first connection point is at the first sonar module and is configured to control transmission of the first sonar ping from the first sonar transducer. The second connection point is to the second sonar module and controls the transmission of the second sonar ping from a second sonar transducer. The synchronization wire transfers an electrical current between the first and second sonar module. This current signal is then processed in the sonar modules and may cause or prevent sonar pings based on the voltage level of the synchronization wire.

While such systems have been successful in reducing the crosstalk sonar interference issue, it has led to other issues. For example, routing of the additional wire between the control heads, the additional cost of the additional hardware needed for operation of such system, and the reduction in the overall system reliability all increase the cost and reduce the desirability of such system.

Still other attempts to synchronize pinging within different timing windows, e.g., via predetermined timing rules to prevent cross-interference, have also been proposed. One such system uses an RS-485 multi-drop communication channel to control the pinging of the transducers in a master-slaves relationship. Such systems set a timing rule so that the transducers can be activated simultaneously or, more generally, according to a predetermined pattern selected so that the interference between transducers is minimized. However, the RS485 multi-drop communication channel requires a networked synch command for the non-master sonar systems. The master sonar system transmits normally and provides the synch commands to the slave sonar systems. Unfortunately, such system bears similar reduction-in-performance issues as does the token passing attempts discuss above. For many of the advanced sonar imaging systems, e.g., live sonar imaging, this reduction in performance to accommodate the other onboard sonar systems may result in an inability to visualize fish swimming or jig tracking, which is often a primary reason to purchase and install such advanced sonar imaging systems.

What is needed is a system and method that allows for simultaneous usage of multiple sonar systems of multiple fish finder control heads, including traditional 2D sonar and advanced sonar imaging systems, without causing crosstalk interference between or reducing performance of such sonar systems. Embodiments of the present invention provides such a system and method. These and other advantages of the invention, as well as additional inventive features, will be apparent from the description of the invention provided herein.

### BRIEF SUMMARY OF THE INVENTION

In view of the above, certain embodiments of the present invention provide a new and improved system and method that allows for simultaneous usage of multiple sonar systems of multiple fish finder control heads, including traditional 2D sonar and advanced sonar imaging systems, without causing crosstalk interference between or reducing performance of such sonar systems. More particularly, certain embodiments of the present invention provide systems and methods of control and coordination among multiple sonar transducers on a recreational fishing boat to reduce interference therebetween utilizing precise time protocol (PTP) network-based ping synchronization. Still more particularly, certain embodiments of the present invention provide such control and coordination among the various fish finder control heads operating sonar transducers by utilizing PTP network-based ping synchronization via a PTP network configured according to the IEEE 1588 standard of which the various fish finder control heads are members.

In one embodiment, the system and method of ping synchronization utilizes a software solution between multiple devices on the same network which have hardware compatible with PTP. The systems and methods are not limited to embodiments that only have to two devices, nor to embodiments utilizing only sonar modules, but are also applied to embodiments utilizing transducers such as advanced sonar imaging systems and live sonar, and embodiments having multiple fish finder control heads which drive 2D, DI, SI, and 360° sonar. In certain embodiments, the members of such systems and methods share a network connection and include PTP supported hardware.

In an embodiment of the present invention, a system for use on a recreational watercraft to enable simultaneous usage of multiple sonar systems operated by multiple fish finders installed on the recreational watercraft without causing crosstalk interference between or reducing performance of such sonar systems includes a precise time protocol (PTP) enabled network configured in accordance with IEEE 1588 standard. At least two fish finders are installed on the recreational watercraft, and each of the fish finders are members of the PTP enabled network. At least one sonar system is operated by each of the fish finders, and each of the fish finders control pinging of the sonar system operated by each of the fish finders in accordance with a ping schedule, and not based on token or permission passing techniques.

In a particular embodiment, the PTP enabled network is configured as a hierarchical master-slave time architecture for clock distribution among the at least two fish finders. Preferably, one of the fish finders is designated as a synchronization master having a grandmaster (GM) clock based on a Best Master Algorithm (BMA) implemented in a library that runs IEEE 1588. The synchronization master multicasts a synchronization message to the others of the fish finders, and the others adjust their local system clocks in accordance with the synchronization message to achieve time synchronization with the GM clock.

In an embodiment, the local system clock is one of a PTP hardware clock or a PTP software clock configured to achieve a time synchronization within a jitter requirement ranging from about 1 to 100° microseconds.

In an embodiment, each of the at least two fish finders derive a ping clock from its local system clock to achieve a low jitter ping rate when to command its at least one sonar system operated thereby to transmit in accordance with the ping schedule. Preferably, the ping rate is dependent on a depth setting for the at least one sonar system.

In another embodiment, one of the fish finders is designated as a synchronization master of the PTP enabled network, and each of the fish finders broadcast sonar operating parameters for each of the at least one sonar system it operates. The synchronization master uses the sonar operating parameters from each of the at least two fish finders to generate the ping schedule. In an embodiment, the sonar operating parameters include at least one of frequency band, distance, range, or ping rate.

In a further embodiment, the ping schedule includes groupings of compatible fish finders based on similar sonar operating parameters for each of the at least one sonar system operated thereby that can all ping during a precise time slot. Preferably, each precise time slot in the ping schedule need not be identical to one another in any particular synchronization period. Further, each precise time slot in the ping schedule need not be identical from one synchronization period to another synchronization period. In an embodiment, an overall time for each precise time slot includes a time to ping and listen for echoes based on the sonar requirements for each sonar type operating in each precise time slot.

In an embodiment, when a sonar ping rate of different transducers of the sonar systems are not the same but only similar, the ping schedule is set to require the fish finders operating such similar sonar transducers to ping at the exact same time. In another embodiment, the ping schedule includes groupings of non-compatible fish finders based on dissimilar sonar operating parameters for each of the sonar system operated thereby that can only ping during mutually exclusive time slots. Preferably, sonar systems using any of two-dimensional, down imaging, or side imaging transducers are grouped in mutually exclusive time slots from sonar system using live sonar transducers.

In one embodiment the ping schedule is broadcast to all of the fish finders, and each of the fish finders utilize the ping schedule to govern operation of the sonar system operated thereby. In an embodiment, at least one of the sonar systems operated by each of the fish finders is a 2D sonar system. In another embodiment, at least one of the sonar systems operated by each of the fish finders is an advanced sonar imaging system. In yet another embodiment, at least one of the fish finders operates at least two sonar systems, and coordinates operation of the at least two sonar systems operated thereby.

In another embodiment, a method for use on a recreational watercraft of enable simultaneous usage of multiple sonar systems operated by multiple fish finders installed on the recreational watercraft without causing crosstalk interference between or reducing performance of such sonar systems is provided. The recreational watercraft has a precise time protocol (PTP) enabled network configured in accordance with IEEE 1588 standard of which the fish finders are members. Preferably, the method includes the steps of collecting, by a network ping synchronizer, ping requirements of the multiple sonar systems broadcast by the multiple fish finders and sorting the multiple fish finders into groups based on similar ping requirements of the multiple sonar systems operated by the multiple fish finders.

The method also includes the steps of generating a ping schedule including time slots for the groups of compatible fish finders based on similar sonar operating parameters of the sonar systems operated thereby that can all ping during the precise time slot to control pinging of the sonar systems operated by the multiple fish finders, and broadcasting the ping schedule to the multiple fish finders for use thereby to control pinging of the sonar systems operated by the multiple fish finders.

The method also includes the steps of multicasting a synchronization message to multiple fish finders for adjustment of the multiple fish finders'local system clocks to achieve time synchronization, and deriving in each of the multiple fish finders a ping clock from the local system clock to achieve a low jitter ping rate when to command the sonar system operated thereby to transmit in accordance with the ping schedule.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a simplified networking diagram illustrating an installation of fishing equipment configured and operated in accordance with an embodiment of the present invention having a trolling motor with i-Pilot Link and built-in MEGA Imaging, two bow-mounted fish finder units, MEGA 360° Imaging, two console-mounted fish finder units, two shallow water anchors, with heading sensor GPS puck and high-speed transducer with y-cable;

FIG. 2 is a simplified networking diagram illustrating a simplified installation of two networked fish finders configured and operated in accordance with an embodiment of the present invention each controlling a single sonar transducer;

FIG. 3 is a synchronization timeline illustration of the operation of a grandmaster (GM) and clock synchronization across fish finders and the derivation of ping clock time slots in accordance with an embodiment of the present invention; and

FIG. 4 is a communications flow diagram illustrating generation and distribution of a ping schedule from the ping requirements of the various transducers and sonar systems installed on a recreational fishing vessel by an embodiment of the network ping synchronizer of the present invention; and

FIG. 5 is a simplified timing diagram illustrating a ping schedule constructed in accordance with the teachings of the present invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

The following detailed description will provide a discussion of various embodiments of the present invention with reference to the accompanying drawings for an exemplary recreational fishing boat to which the present invention is particularly well suited to aid in the understanding of the various features, functioning, and operation of such embodiments. It should be noted, however, that while the following will describe embodiments of the present invention with regard to this exemplary operating environment, there is no intention to limit the scope of the invention to such. Indeed, the description of the examples that follow should be taken by way of example and not by way of limitation. Indeed, those skilled in the art will recognize from the following that other embodiments within the scope of the present invention are possible and within the scope thereof.

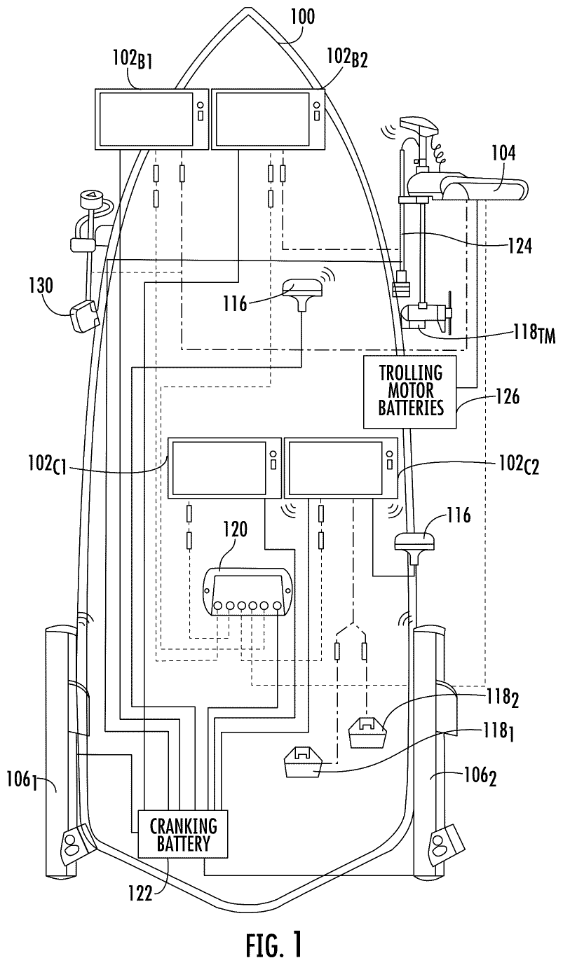

With reference to FIG. 1, there is illustrated a simplified networking diagram for a recreational fishing watercraft 100. In this embodiment, the watercraft 100 has installed thereon two bow mount fish finders 102_{B1} and 102_{B2} in addition to a bow mount trolling motor 104. The trolling motor 104 may include an integrated sonar transducer 118_{TM}, such as a MEGA Side Imaging, MEGA Down Imaging, dual spectrum CHIRP, etc. It may also include a MEGA 360° imaging sonar transducer 124 provided therewith. This embodiment also includes a bow mount MEGA Live sonar transducer 130 and Target Lock system providing independent steering of the MEGA Live sonar transducer 130, although other embodiments may utilize the steering control of the trolling motor 104 if mounted thereto or integrated therein, manual steering, etc. The trolling motor 104 utilizes a dedicated trolling motor battery 126 (or bank of batteries) and receives heading information from sensor 116_{TM}.

This exemplary installation also includes two console mount fish finders 102_{C1} and 102_{C2}, a pair of transducer assemblies 118₁ and 118₂, and a GPS and heading sensor 116_{C}. Depending on the angler's preferences, the transducers 118₁ and 118₂ may include a MEGA Side imaging transducer, down imaging transducer, etc. As with other more complex installations, an ethernet switch 120 may also be used in order to ensure proper networking of the various components thereon. A pair of shallow water anchors 106₁ and 106₂ are also utilized in the illustrated embodiment and are powered from the cranking battery 122 of the watercraft 100.

The trolling motor 104 and the multiple fish finders 102_{B1}, 102_{B2}, 102_{C1}, and 102_{C2} are networked on the watercraft 100, e.g., via the One-Boat Network® (OBN) provided by the assignee of the instant application. Such networking may utilize Ethernet and allows the trolling motor 104 and the fish finders 102_{B1}, 102_{B2}, 102_{C1}, and 102_{C2} to connect and share information like waypoints, tracks, and transducer information. Such networking makes it easy to access the information and boat control features from anywhere in the boat 100.

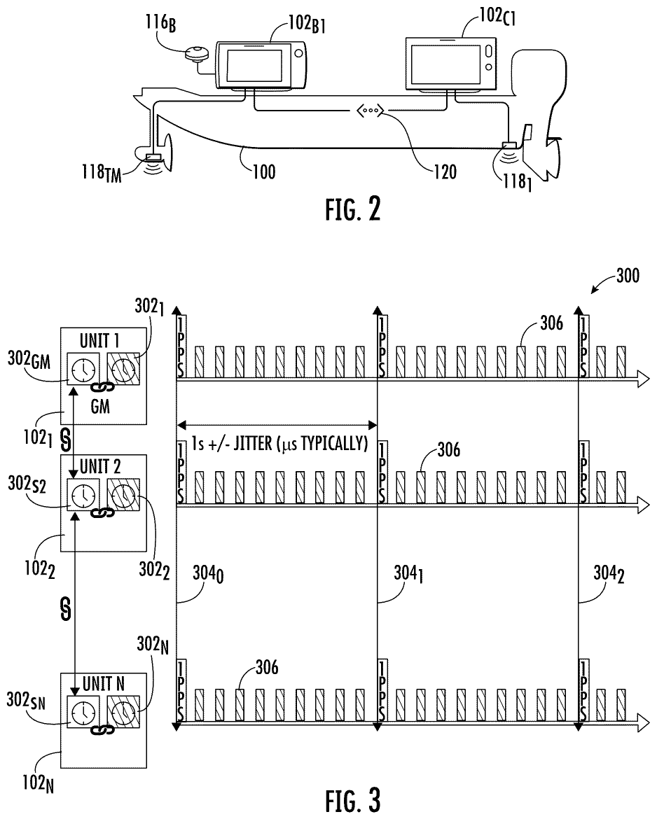

In the embodiment illustrated in FIG. 1, the Ethernet switch 120 allows connection of up to five Ethernet capable products. While not shown in FIG. 1, the network can contain multiple Ethernet switches daisy chained together to allow additional products to be networked. The Ethernet switch 120 may also be used in more simplified embodiments, such as that shown in FIG. 2 having only two fish finders 102_{B1} and 102_{C1} and two transducers 118_{TM} and 118₁. However, in such and other networks, the Ethernet switch 120 is optional.

In order to avoid or reduce the crosstalk interference issue discussed above, embodiments of the present invention utilize ping synchronization between or among the fish finders 102 installed on the watercraft 100 that is not based on token or permission passing techniques that otherwise adversely affect the overall performance of the sonar systems. Instead, embodiments of the present invention utilize a Precise Time Protocol (PTP), such as the Institute of Electrical and Electronics Engineers (IEEE) Standard for a Precision Clock Synchronization Protocol for Networked Measurement and Control Systems, IEEE 1588. Each of the fish finders 102 operating a transducer 118, 124, 130 to be synchronized are connected to the same PTP-enabled network, which can span multiple switch hops in various embodiments, although need not include any in more simplified embodiments.

As described by the IEEE, the IEEE 1588 “standard defines a protocol enabling precise synchronization of clocks in measurement and control systems implemented with technologies such as network communication, local computing and distributed objects. The protocol is applicable to systems communicating by local area networks supporting multicast messaging including but not limited to Ethernet. The protocol enables heterogeneous systems that include clocks of various inherent precision, resolution, and stability to synchronize to a grandmaster clock. The protocol supports system-wide synchronization accuracy in the sub-microsecond range with minimal network and local clock computing resources. The default behavior of the protocol allows simple systems to be installed and operated without requiring the administrative attention of users. The standard includes mappings to UDP/IP, DeviceNet and a layer-2 Ethernet implementation.”

In accordance with embodiments of the present invention, a PTP, such as the IEEE 1588, is used to establish a hierarchical master-slave time architecture for clock distribution. A synchronization master is selected for the network, and time is distributed from the master to the slaves. The master, or Grandmaster (GM) using the parlance of the IEEE 1588, for the entire network transmits time synchronization information to the slaves. Using this information, the slaves periodically adjust their local system clocks (a PTP Hardware Clock (PHC), or a PTP Software Clock (SW PHC), referred to herein generally as “PHC”), allowing them to achieve time synchronization within a specific jitter requirement, typically in the 1 to 100 microsecond range, from the GM. Selection of the GM is controlled through the IEEE 1588 protocol and uses a Best Master Algorithm (BMA) implemented in a library that runs IEEE 1588, e.g., via Linux or a third-party library. Such BMA is self-healing such that if the GM leaves the network, BMA is run amongst the remaining nodes to determine a new GM.

FIG. 3 illustrates a synchronization timeline 300 used in certain embodiments. As illustrated, a GM clock 302_{GM} of one of the fish finders 102₁ (selection of which is governed by the IEEE 1588 BMA as discussed above) periodically transmits a multicast synchronization message 304₀, 304₁, 304₂, etc. on the network, e.g., at one pulse-per-second (PPS). Each of the slave fish finders 102₂ . . . 102_{N} use the synchronization message 304₀, 304₁, 304₂, etc. to adjust and lock their PHC 302_{S2} . . . 302_{SN} in synchronization with the GM clock 302_{GM}. The ping clocks 302₁ . . . 302_{N} are derived and synchronized for each fish finder 102₁, 102₂ . . . 102_{N} from its PHC (302_{GM}, 302_{S2} . . . 302_{SN}) to achieve a desired low jitter ping rate.

The ping rate is the number of times per second that a fish finder 102₁, 102₂ . . . 102_{N} will transmit sonar waves into the water and is limited to the time slots 306 between synchronization messages 304. The illustrated gaps between time slots 306 are exaggerated in this FIG. 3 and are effectively only the length of the jitter. The ping rate is dependent on angler desired depth settings on the fish finders 102₁, 102₂ . . . 102_{N}. For example, if an angler sets the fish finders 102₁, 102₂ . . . 102_{N} to a depth setting of 8,500 feet, the ping rate would be 0.3 Hz to allow for round trip sonar ping time. At a depth setting of, e.g., 30 feet, a ping rate of 20 Hz could be used. A higher range of ping rates may be used in embodiments used for ice fishing and related cold water uses.

In the illustrated embodiment, the PTP and PHC synchronization happens once per second (1 PPS), although the synchronization frequency can be longer or shorter based on the IEEE 1588 standard. Between synchronizations, all of the ping clocks 302₁, 302₂ . . . 302_{N} operate to control the timing of pinging operation of each of the fish finders 102₁, 102₂ . . . 102_{N} to avoid or reduce the crosstalk interference. The actual ping rate for each fish finder 102₁, 102₂ . . . 102_{N} depends on the desired depth or range within which this unit is gathering sonar data as discussed above. As such, the actual ping rate between fish finders 102₁, 102₂ . . . 102_{N} may differ based on angler settings and usage, although such pinging may only occur during the time slots 306.

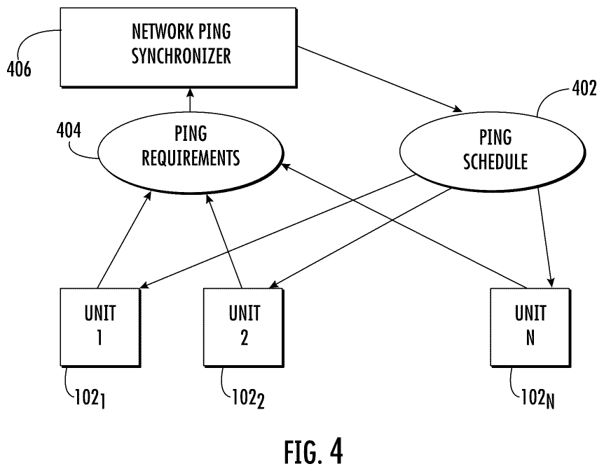

While the PTP enables ping synchronization generally, such alone is not sufficient on an actual recreational fishing watercraft 100 on which different sonar systems are installed and operated simultaneously. In order to accommodate the different angler-required operating modes and settings of range and depth for these different sonar systems, which drive different ping rates for the various transducers and sonar systems, while still eliminating or reducing the crosstalk interference, embodiments of the present invention utilize a ping schedule 402, or in another embodiment groups of fish finders of similar ping requirements such as frequency band, distance, range, or ping rate, as shown in FIG. 4.

In order to generate the ping schedule 402, or grouping of fish finders, e.g., a time slot during which selected fish finder(s) can ping, each fish finder 102₁, 102₂ . . . 102_{N} transmits its sonar operating parameters for each transducer or sonar system it operates, e.g., frequency band, distance, range, ping rate, etc., required for the next synchronization period. These individual ping requirements are stored in a database 404 that is used by the network ping synchronizer 406 to determine individual or groups of fish finders having unique or similar ping requirements, e.g., frequency band, distance range, required ping rate, etc. as discussed below.

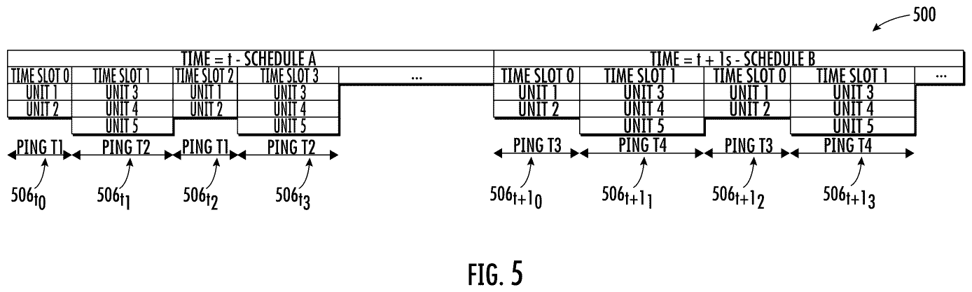

In order to accommodate an angler's changing of such requirements/settings in real time, this ping schedule 402 is planned for the next synchronization period, e.g., for the next second using the synchronization message 304 rate illustrated in FIG. 3. However, the ping schedule 402 may be planned to cover additional synchronization periods. As may be observed from FIG. 5, the time slots in the ping schedule 402 need not be identical to one another, nor from one synchronization period to the next. This is because the ping duration may vary based on the individual angler settings for the particular sonar systems installed on the watercraft, and over time as the angler changes them throughout the fishing excursion based on the sonar requirements discussed above. The overall time for each slot includes the time to ping and listen for echoes based on the sonar requirements for each of the sonar types operating in each time slot.

This ping schedule 402 or grouping is then shared between all of the fish finders 102₁, 102₂ . . . 102_{N} and is used to govern the operation of the transducers and sonar systems operated thereby. As the ping schedule 402 is updated based on changing sonar requirements as discussed above, it is also shared between all of the finders 102₁, 102₂ . . . 102_{N} and is used to govern the operation of the transducers and sonar systems operated thereby based on these new requirements.

While FIG. 4 illustrates the network ping synchronizer 406 and the associated database 404 functionally outside of any one fish finder 102₁, 102₂ . . . 102_{N} , as with the designation of any one of the fish finders 102₁, 102₂ . . . 102_{N} as the GM, this functionality can be accomplished by any of the fish finders 102₁, 102₂ . . . 102_{N} or other networked controller on the watercraft. In one embodiment, the fish finder designated as the GM assumes this function.

As illustrated in FIG. 5, the ping schedule 500 is composed of precise, low jitter time slots 506ₜ₀, 506ₜ₁, 506ₜ₂, 506ₜ₃ . . . 506₍ₜ₊₁ₛ₎₀, 506₍ₜ₊₁ₛ₎₁, 506₍ₜ₊₁ₛ₎₂, 506₍ₜ₊₁ₛ₎₃ . . . of length Tn that trigger specific ping events. In one embodiment they are reserved for specific fish finders 102₁, 102₂ . . . 102_{N} to ping. In another embodiment, groups of units or time slots may be defined.

The selection of which fish finders 102₁, 102₂ . . . 102_{N} are assigned to which time slots 506ₜ₀, 506ₜ₁, 506ₜ₂, 506ₜ₃ . . . in each synchronization period in one embodiment is made in order to achieve the goal of grouping compatible units together so that they can all ping at precise time and/or grouping non-compatible units into mutually exclusive time slots.

In one embodiment, the ping schedule 402 is set such that no 2D, DI, or SI sonar transducers may ping during the same time slot that a live sonar system is pinging. However, in other embodiments, such restriction based on sonar type is not utilized and instead the other ping requirements are solely used to set the ping schedule 402. In certain embodiments, when the sonar ping rate of different transducers are not the same but only similar, the ping schedule 402 is set to require such similar sonar transducers to ping at the exact same time to minimize any crosstalk that might otherwise occur if the pings were originated at slightly different times within the same time slot. In alternate embodiments, such only similar sonar transducer systems are set to ping in different time slots in the ping schedule 402, which has also proven to minimize any crosstalk that might otherwise occur.

As this suggests, precise synchronization of multiple ping-requirement-compatible fish finders within the same time slot based on distribution of the ping schedule prior to the synchronization period during which the pings will occur allows achievement of a maximum ping rate across all fish finders without interference because no synchronization token needs to be circulated as with prior systems. As the preceding also suggests, other embodiments of the present invention mutually exclude fish finders that are not ping compatible or only similar from pinging during the same synchronization period, also with a precise timing, while still allowing high ping-requirement-compatible fish finders to be synchronized in other synchronization periods, without interference.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A system for use on a recreational watercraft to enable simultaneous usage of multiple sonar systems operated by multiple fish finders installed on the recreational watercraft without causing crosstalk interference between or reducing performance of such sonar systems, comprising:
a precise time protocol (PTP) enabled network configured in accordance with IEEE 1588 standard;
at least two fish finders installed on the recreational watercraft, each of the at least two fish finders being members of the PTP enabled network;
at least one sonar system operated by each of the at least two fish finders; and
wherein each of the at least two fish finders control pinging of the at least one sonar system operated by each of the at least two fish finders in accordance with a ping schedule and not based on token or permission passing techniques.

2. The system of claim 1, wherein the PTP enabled network is configured as a hierarchical master-slave time architecture for clock distribution among the at least two fish finders.

3. The system of claim 2, wherein one of the at least two fish finders is designated as a synchronization master having a grandmaster (GM) clock based on a Best Master Algorithm (BMA) implemented in a library that runs IEEE 1588, wherein the synchronization master multicasts a synchronization message to the others of the at least two fish finders, and wherein the others of the at least two fish finders adjust their local system clocks in accordance with the synchronization message to achieve time synchronization with the GM clock.

4. The system of claim 3, wherein the local system clock is one of a PTP hardware clock or a PTP software clock configured to achieve a time synchronization within a jitter requirement ranging from about 1 to 100 microseconds.

5. The system of claim 3, wherein each of the at least two fish finders derive a ping clock from its local system clock to achieve a low jitter ping rate when to command its at least one sonar system operated thereby to transmit in accordance with the ping schedule.

6. The system of claim 5, wherein the ping rate is dependent on a depth setting for the at least one sonar system.

7. The system of claim 1, wherein one of the at least two fish finders is designated as a synchronization master of the PTP enabled network, wherein each of the at least two fish finders broadcast sonar operating parameters for each of the at least one sonar system it operates, wherein the synchronization master uses the sonar operating parameters from each of the at least two fish finders to generate the ping schedule.

8. The system of claim 7, wherein the sonar operating parameters include at least one of frequency band, distance, range, or ping rate.

9. The system of claim 7, wherein the ping schedule includes groupings of compatible fish finders based on similar sonar operating parameters for each of the at least one sonar system operated thereby that can all ping during a precise time slot.

10. The system of claim 9, wherein each precise time slot in the ping schedule need not be identical to one another in any particular synchronization period.

11. The system of claim 9, wherein each precise time slot in the ping schedule need not be identical from one synchronization period to another synchronization period.

12. The system of claim 9, wherein an overall time for each precise time slot includes a time to ping and listen for echoes based on the sonar requirements for each sonar type operating in each precise time slot.

13. The system of claim 7, wherein when a sonar ping rate of different transducers of the sonar systems are not the same but only similar, the ping schedule is set to require the fish finders operating such similar sonar transducers to ping at the exact same time.

14. The system of claim 7, wherein the ping schedule includes groupings of non-compatible fish finders based on dissimilar sonar operating parameters for each of the at least one sonar system operated thereby that can only ping during mutually exclusive time slots.

15. The system of claim 14, wherein sonar systems using any of two-dimensional, down imaging, or side imaging transducers are grouped in mutually exclusive time slots from sonar system using live sonar transducers.

16. The system of claim 7, wherein the ping schedule is broadcast to all of the at least two fish finders, and wherein each of the at least two fish finders utilize the ping schedule to govern operation of the at least one sonar system operated thereby.

17. The system of claim 1, wherein at least one of the at least one sonar system operated by each of the at least two fish finders is a 2D sonar system.

18. The system of claim 1, wherein at least one of the at least one sonar system operated by each of the at least two fish finders is an advanced sonar imaging system.

19. The system of claim 1, wherein at least one of the at least two fish finders operates at least two sonar systems, and wherein the at least one of the at least two fish finders coordinates operation of the at least two sonar systems operated thereby.

20. A method for use on a recreational watercraft of enable simultaneous usage of multiple sonar systems operated by multiple fish finders installed on the recreational watercraft without causing crosstalk interference between or reducing performance of such sonar systems, the recreational watercraft having a precise time protocol (PTP) enabled network configured in accordance with IEEE 1588 standard of which the fish finders are members, comprising the steps of:
collecting, by a network ping synchronizer, ping requirements of the multiple sonar systems broadcast by the multiple fish finders;
sorting the multiple fish finders into groups based on similar ping requirements of the multiple sonar systems operated by the multiple fish finders;
generating a ping schedule including time slots for the groups of compatible fish finders based on similar sonar operating parameters of the sonar systems operated thereby that can all ping during the precise time slot to control pinging of the sonar systems operated by the multiple fish finders;
broadcasting the ping schedule to the multiple fish finders for use thereby to control pinging of the sonar systems operated by the multiple fish finders;
multicasting a synchronization message to multiple fish finders for adjustment of the multiple fish finders'local system clocks to achieve time synchronization;
deriving in each of the multiple fish finders a ping clock from the local system clock to achieve a low jitter ping rate when to command the sonar system operated thereby to transmit in accordance with the ping schedule.
